(19) United States
(12) Patent Application Publication
(10) Pub. No.: US 2012/0224362 A1
(43) Pub. Date: Sep. 6, 2012

(54) Lighting Apparatus and Method of Lighting

(75) Inventor: Jason Sheffield, Cleator (GB)

(73) Assignee: NUCLEAR DECOMMISSIONING AUTHORITY, Moor Row, Cumbria (GB)

(21) Appl. No.: 13/395,698

(22) PCT Filed: Sep. 10, 2010
(86) PCT No.: PCT/GB2010/051520

§ 371 Date: May 16, 2012

(30) Foreign Application Priority Data
Sep. 14, 2009 (GB) 0916040.9

(51) Int. Cl. F21V 5/04; B23P 17/04; F21V 21/00; F21V 31/00; B25J 21/02; F21V 19/00

(52) U.S. Cl. 362/217.12; 362/235; 362/311.01; 362/365; 29/401.1

(57) ABSTRACT

The invention provides a lighting apparatus which comprises housing means, illumination means and fixing means, wherein the illumination means is comprised in an end surface of the housing means, and the fixing means is located on an outer surface of the housing means and is adapted to securely locate the lighting apparatus in a window for use in a glovebox. Preferably, the housing means comprises an essentially cylindrically shaped carrier, adapted for insertion within a CRL window, the illumination means comprises a lighting element comprising a LED light source and a lens arrangement, and the fixing means comprises an annular seal which is integral with the housing means. The invention also provides a lighting system including a plurality of lighting apparatus, an illuminated glovebox and a method of illuminating a glovebox.

### FIELD OF THE INVENTION

This invention relates to a lighting apparatus and a method of using this apparatus. The invention has particular, but not exclusive, utility in glovebox operations used for the handling of radioactive and other toxic materials.

### BACKGROUND TO THE INVENTION

It is frequently the case that, when handling hazardous material within glovebox environments, difficulties are encountered in carrying out operations as a consequence of poor visibility, which is a consequence of the fact that lighting levels within existing gloveboxes are not always adequate for the detailed work carried out, whether it be for maintenance, production operations or breakdown recovery. In order to overcome this deficiency, additional temporary lighting is often required. Several potential methods are known from the prior art involving, for example, “bagging-in” hand-held light batons for localised lighting within the glovebox, or temporarily arranging ad hoc lighting arrangements near to the glovebox windows such that they shine into the glovebox.

A common practice which is well known in the art involves shining a torch or other light source through a Central Research Laboratories (CRL) window, which is a standard unit that replaces a glove within a gloveport and seals the glovebox, but contains a viewing window. When the CRL window is in place, the torch or lamp is shone through the window with the beam of light concentrated on the work area. However, a commonly encountered difficulty with the use of a torch or similar temporary lighting arrangement is that the illumination is poor and does not always provide good visibility for glovebox working. Frequently, for example, the torch requires to be repositioned to follow the working activity as it moves around the glovebox. In addition, it is often found that reflections from the window hamper operations.

Thus, in order to avoid overcomplicating simple tasks, the torch is typically held by hand, thereby frequently requiring two personnel to complete a task which could otherwise be undertaken by a single person. As a consequence, an extra person would be unnecessarily exposed to the risk and radiation dose of glovebox working. For tasks that are more complicated and time consuming, it may on occasions be required that an ad hoc bracket be fashioned in order that the torch or lamp can be fixed in place. In other situations, it may be the case that torches or other lighting implements are posted into the glovebox, but attendant problems then arise as a consequence of the requirement to subsequently dispose of the torches and, more especially, any associated batteries.

The present invention, therefore, seeks to alleviate, at least partially, some or all of the problems associated with the prior art.

### SUMMARY OF THE INVENTION

Thus, in accordance with a first aspect of the present invention there is provided a lighting apparatus which comprises housing means, illumination means and fixing means, wherein said illumination means is comprised in an end surface of said housing means, and said fixing means is located on an outer surface of said housing means and is adapted to securely locate said lighting apparatus in a window for use in a glovebox.

Preferably, said housing means comprises an essentially cylindrically shaped carrier, adapted for insertion within a CRL window.

Preferably, said illumination means comprises a lighting element and a lens arrangement. Most preferably, said lighting element comprises a LED light source; especially preferably said lighting element comprises a plurality of LED light sources which, typically, are arranged around the periphery of inner side walls of an essentially cylindrically shaped carrier, and said lens arrangement comprises a laser-etched graticule comprised in a circular lens fitting which is positioned at one end of said cylindrical housing means, and thereby comprises an end surface of said housing means. In such a preferred embodiment, light is emitted from each channel in the graticule, thereby providing a floodlight effect across essentially the entire surface of the lens arrangement. Such an arrangement is particularly effective if the end surface is a reflective graticule, adapted to provide a flat light source which can be held in position adjacent the window.

Preferably, said fixing means comprises at least one projecting element held on the outer surface of the housing means, the at least one projecting element projecting outwardly away from the carrier. In the preferred embodiment wherein said housing means comprised cylindrical housing means, said fixing means is preferably located on the cylindrical surface of said housing means, and preferably extends around substantially the full circumference of said housing means, so as to facilitate positioning and securing of said lighting apparatus within a CRL window.

In a preferred embodiment of the invention, said fixing means comprises an annular seal. Most preferably, said fixing means is integral with the housing means.

Preferably, said apparatus additionally comprises power supply means, connected to said lighting element. Most preferably, said power supply means comprises a power cable which exits said apparatus through an end surface of said housing means distant from said illumination means.

Most conveniently, said lighting element is adapted to remain in the housing means during use and to be removed or replaced when required. Preferably, an opening is formed in the housing means for insertion of the lighting element therein. Most preferably, said opening is provided in an end surface of said housing means distant from said illumination means.

In the most preferred embodiments, wherein said housing means comprises an essentially cylindrically shaped carrier, said carrier is preferably equipped with a substantially cylindrical cover having a handling means provided thereon to enable the lighting apparatus to be removed from or inserted into a glovebox and an open end to facilitate engagement with said carrier. Preferably, said cover is located at the end of the cylindrical carrier distant from the illumination means.

Optionally, said lighting apparatus further comprises a sealable vessel adapted to receive and store the carrier.

According to a second aspect of the present invention, there is provided a lighting system including a plurality of lighting apparatus according to the first aspect of the invention, said system further including power means, operable to couple with each lighting apparatus to operate said lighting apparatus and illuminate the contents of the glove box.

According to a third aspect of the present invention, there is provided an illuminated glovebox, said illuminated glovebox comprising a glovebox and a lighting apparatus according to the first aspect of the invention.

The third aspect of the invention also envisages an illuminated glovebox, comprising a glovebox and a lighting system according to the second aspect of the invention.

According to a fourth aspect of the invention, there is provided a method of illuminating a glovebox, said method comprising retrofitting a glove port fitting assembly with a lighting apparatus by means of the steps of:
(a) removing a given glove port fitting from a glove box;
(b) replacing said glove port fitting with a window fitting; and
(c) fitting a lighting apparatus according to the first aspect of the invention in said window fitting so as to illuminate the glove box.

Preferably, said window fitting comprises a CRL window fitting. Optionally, said method may be applied to more than one glove port fitting, so that the lighting system according to the second aspect of the invention, comprising a plurality of lighting apparatus, may be retrofitted according to the method of the fourth aspect of the invention.

The said method serves to at least partially illuminate the glovebox, and involves suitably locating the lighting element in the lighting apparatus and illuminating the contents of the glovebox.

The method according to the invention provides an illuminated glovebox wherein, in use, the window fitting provides an airtight seal for the contents of the glovebox, such that the lighting apparatus, remaining external to the glovebox environment, can be readily removed at the end of an operation and redeployed elsewhere, or stored away for future use.

Typically, the material within the glovebox may contain hazardous material, such as biological or radioactive material. In the latter case, said radioactive material may include substances that emit alpha-particles including, but not limited to, plutonium or plutonium compounds, or solutions thereof, which are routinely handled in gloveboxes, and mixtures of uranium and plutonium oxides as part of the process of manufacturing nuclear fuel. In the latter case, said radioactive material may include radioactive waste material which may derive from a nuclear reactor, from the reprocessing of said material, or from the manufacture of nuclear fuel. Said radioactive waste material typically includes plutonium, uranium oxide ash, radioactive fission products, or materials used for the manufacture of nuclear fuel and may, for example, further include, unseparated from the said waste, at least partially intact fuel rods and/or at least partially intact fuel canisters.

### BRIEF DESCRIPTION OF THE DRAWINGS

Embodiments of the invention are further described hereinafter with reference to the accompanying drawings, in which:

FIG. 1 shows a cross-section of a lighting apparatus according to an embodiment of the invention located on a glovebox.

FIG. 2 illustrates the arrangement/layout of a glovebox fitted with lighting apparatus according to the invention.

FIG. 3 depicts a gloveport which is not in use, wherein a gloveport cover is placed over the gloveport and is held in position via the CRL fittings; and

FIG. 4 shows a gloveport wherein a lighting apparatus according to the present invention has been inserted into the CRL window device, and the traditional gloveport cover of FIG. 3 has been modified to enable a power supply to the lighting apparatus.

### DETAILED DESCRIPTION OF THE INVENTION

The present invention provides an apparatus as hereinbefore defined that allows for easy fixing to an existing gloveport fixing, and typically to a CRL fixing. Thus, in order to overcome the problem of having to shine a torch or lamp through a gloveport window, an LED light and reflector mechanism is held in position on the outside of the glovebox, within the CRL window. The gloveport LED light utilises a commercially available LED source and may be connected to locally mounted power sources in order to provide a more permanent solution to the problem of poorly illuminated gloveboxes.

In a preferred embodiment, the apparatus may comprise housing means comprising a substantially cylindrical carrier having an internal cylindrical surface and an external cylindrical surface and, substantially coaxial with the axis of rotation and located on the external wall of the carrier, fixing means comprising a carrier projecting element extending around substantially the full circumference of the external cylindrical wall of the carrier, the carrier projecting element comprising an annular ring being arrayed on the external cylindrical wall of the carrier adjacent an end of the cylinder wherein is comprised illumination means comprising an LED light source, and wherein said apparatus is additionally equipped with a substantially cylindrical cover having a handling means provided thereon, said cover being located at the end of the cylindrical carrier distant from the illumination means, and serving to shield the operating area from potentially harmful radiation.

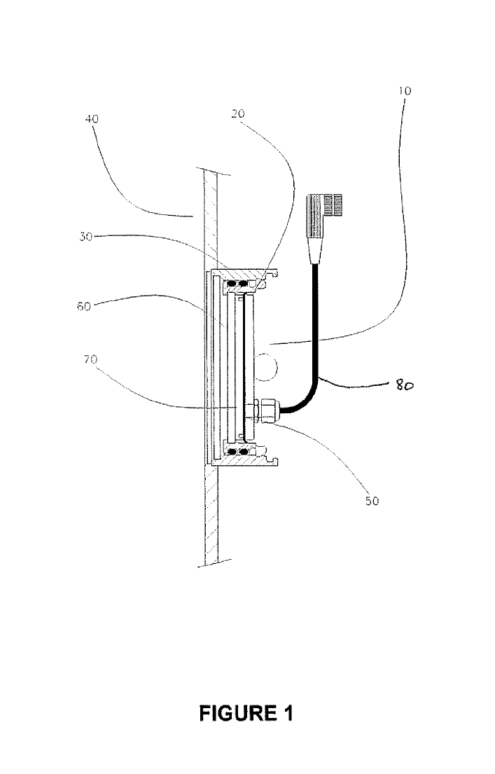

Turning now to the accompanying drawings, there is illustrated in FIG. 1 a first embodiment of the invention which comprises a lighting arrangement, preferably a cylindrical carrier assembly, which fits into the central opening of a gloveport window fitting, for instance a CRL fitting, and incorporates a lighting means which ensures illumination of the glovebox. The carrier is also provided with an arrangement of sealing surfaces and members which act to hold the lighting arrangement in position within the gloveport window fitting. This arrangement acts solely to securely locate the lighting unit in position; it does not provide containment of the glovebox which is done by the window fitting.

As can be seen in FIG. 1, the carrier 10 has an outer surface 20, preferably cylindrical, which is capable of being inserted into a gloveport window fitting, for instance a CRL fitting 30 of a glovebox 40. The fitting 30 has an inner cylindrical surface and an outer cylindrical surface. The outer surface 20 of the carrier fits within the inner cylindrical surface of the fitting. The carrier 10 is secured within the inner cylindrical surface of the fitting 30 using a resilient sealing element 50. The carrier 10 is rotatable with respect to housing 30.

The glovebox 40 is provided with a removable window 60. The window has an inner surface, facing into the glovebox, and an outer surface, facing out of the glovebox. The window acts as a physical barrier that maintains the containment of the glovebox. In use, the carrier 10 is located in the fitting 30 so that the light being emitted from the assembly is directed towards the window 60 for illumination of the glovebox 40.

In this embodiment comprising an LED lighting array, the surface of the carrier 10 which is in contact with the outer surface of the window 60 is provided with an annular opening (not shown) for an illumination source 70. The source 70 is powered by means of a cable 80, which is an electric cable connected to a 12 V DC power supply. The source 70 is secured in the opening by means of an adhesive, which seals it to a surface of the annular opening.

The seal 50 acts as a friction fit holding device and is a projecting element providing substantially frustoconical inner and outer surfaces. The main feature of the carrier 10 is that it is easily inserted into the CRL type window using the integrated rubber seal to give a secure friction fit.

The arrangement of close fitting seals, and the close proximity of the light source to the gloveport window, is facilitated by the use of LEDs which are compact and generate little heat; such an arrangement would be difficult to arrange with more conventional lighting sources.

Positioning of the light source close to the window provides efficient transmission of the light into the glovebox, both because of geometric considerations and the minimising of losses by reflection. Operations within the glovebox are further facilitated by the properties of the reflector, which ensure an even pool of illumination within a wide working area.

The compact nature of the design allows a radiation shielding cover to be fitted and left in place over the port. The use of such covers, known as shielding ports, is common for workforce protection in situations where there is significant radiation emanating from the gloveport. Typically, the covers would have to be removed to enable the use of a torch or similar lighting arrangement, thereby increasing the workforce exposure to radiation. The facility to leave the LED assembly in situ behind a shielding port, and activate it remotely, obviates the need for removal of the shielding port, thereby reducing the workforce exposure to radiation.

The carrier 10 offers several advantages, specifically:
The unit provides better illumination than alternative incandescent lights and fluorescent tube based alternatives. Where a torch or lamp might give a more directed beam of light to the area concerned, the LED light sheet gives a greater spread of diffused light.
Personnel no longer need to handle or fabricate brackets to hold a torch or lamp whilst carrying out their duties.
The LED light power consumption is less than 24 watts at 12 V DC (depending on the size). This is much safer when compared to the 110 V or 230 V AC supplies for the designs of lamps which are commonly employed. Furthermore, the heat loading of the glovebox fixtures is considerably less than with other lighting arrangements. In addition, torches are battery operated and only work for a limited period before batteries need replacing.
There is no need for the gloveport cover to be removed from the gloveport when shining the light source through the window; especially for a shielded port, the gloveport cover can remain, reducing personnel dose uptake.
The life expectancy of the LED light in operation is approx. 50000 hours, which is considerably more than the life expectancy of a filament or fluorescent lamp.
The LED light assembly, mainly consisting of Perspex, is considerably more robust than the glass filament or fluorescent lamps, an important consideration in an environment where sharp fragments can damage the glovebox integrity.
Not only can the gloveport covers with LED light assembly according to the invention be used in a gloveport for a more permanent enhancement to the existing lighting, they can also be interchanged between gloveports and gloveboxes very easily, without challenging the containment of the glovebox.
The versatility of the components used in the manufacture of the light assembly gives the ability to manufacture varying sizes of gloveport LED lights for a range of standard size gloveports, most particularly for 6 inch ports and 9 inch ports.

In order to highlight the advantages and to show the improvement in practice, a trial for the LED carrier in operation was setup on a glovebox. This trial gave personnel the opportunity to evaluate the LED carrier in a production-led environment. The glovebox was identified as having reduced lighting levels that were inadequate for the production tasks involved. An assessment was carried out to identify gloveports that could be used for providing additional secondary lighting.

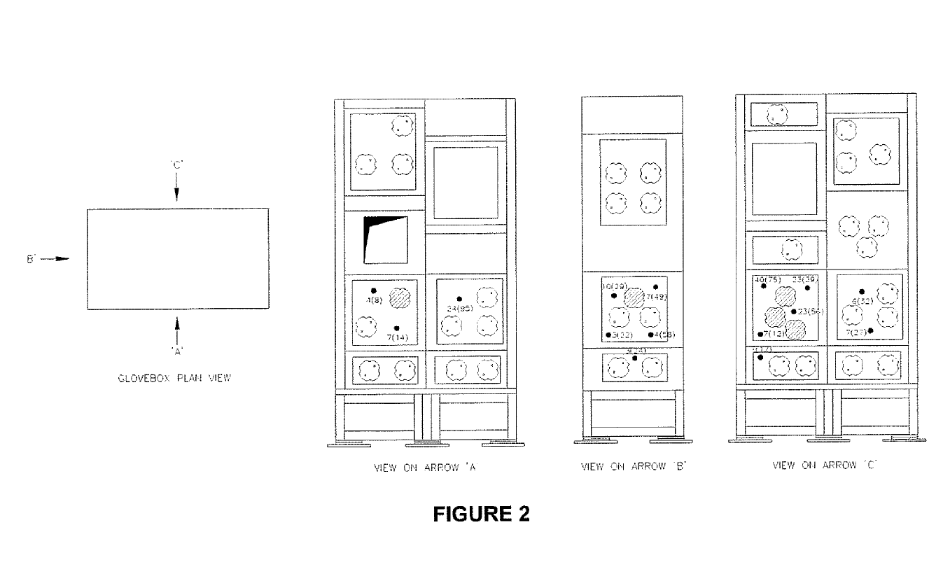

In FIG. 2, there is shown the arrangement/layout of the glovebox and the gloveports where were investigated are identified (hatched). The glovebox was initially surveyed to establish the existing standard lighting levels within, using a calibrated light meter. The light meter was placed on the outside of the glovebox glass, to give a more representative reading of how much light personnel would see from the outside of the glovebox. Several lighting level (Lux) readings at different points where taken (highlighted as dots on FIG. 2) and the findings recorded.

The LED lights were then installed (5 in total) for a three week period, adhering to codes of practice for plant interventions, the Lux readings were taken again at the same points as before, and the findings recorded. The Lux readings are shown next to the dots in FIG. 2, the initial figure being the Lux level for standard lighting and the figure in brackets being the enhanced Lux level at that point. The trial afforded the opportunity for firsthand observation of the improved lighting levels, and it became evident that the LED light units proved to be of great benefit.

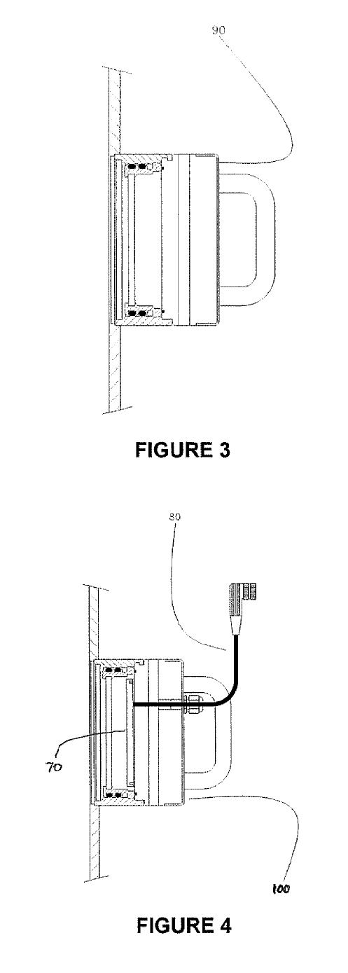

In a further embodiment of the invention, in order to illustrate the capabilities of the LED light assembly and to ensure that it does not interfere with the gloveport classifications with respect to radiation shine paths through the gloveport, the LED carrier can be adapted to fit onto a shielded gloveport cover 90. Traditionally, the gloveports utilise the CRL bayonet type fitting to replace the gloves within the gloveport with a CRL window/bung, using a special tool. In some cases, particularly for additional shielding, a gloveport cover 90 is placed over a gloveport, and is held in position via the CRL fittings, when the gloveport is not in use, as illustrated in FIG. 3.

However, for the purposes of providing additional lighting, the traditional gloveport cover is replaced with a gloveport cover 100 with LED light, as seen in FIG. 4. The gloveport cover 100 has been adapted to enable a power supply cable 80 to pass through it at a predetermined position, so as to allow the power supply cable 80 to be operably connected to the apparatus whilst the gloveport cover 100 is in place. In the illustrated embodiment, the power cable 80 is connected to the part of the lighting apparatus furthest away from the illumination source 70. This arrangement offers the added benefit of having the additional light within the glovebox without compromising the safety of personnel in the immediate vicinity of the shielded gloveport.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-35. (canceled)

36. A lighting apparatus which comprises housing means, illumination means and fixing means, wherein said illumination means is comprised in an end surface of said housing means, and said fixing means is located on an outer surface of said housing means and is adapted to securely locate said lighting apparatus in a window for use in a glovebox, wherein said housing means optionally comprises an essentially cylindrically shaped carrier which is optionally adapted for insertion within a CRL window.

37. A lighting apparatus as claimed in claim 36 wherein said illumination means comprises a lighting element and a lens arrangement, wherein said lens arrangement optionally comprises a circular lens arrangement which is positioned at one end of a cylindrical housing means and comprises an end surface of said housing means.

38. A lighting apparatus as claimed in claim 37 wherein said lighting element comprises one or a plurality of LED light sources, wherein said plurality of LED light sources are optionally arranged around the periphery of inner side walls of an essentially cylindrically shaped carrier.

39. A lighting apparatus as claimed in claim 38 wherein said lens arrangement comprises a laser-etched graticule.

40. A lighting apparatus as claimed in claim 39 wherein said graticule is comprised in a circular lens fitting which is positioned at one end of a cylindrical housing means.

41. A lighting apparatus as claimed in claim 36 wherein said fixing means comprises at least one projecting element held on the outer surface of the housing means, the at least one projecting element projecting outwardly away from the carrier.

42. A lighting apparatus as claimed in claim 36 wherein said housing means comprised cylindrical housing means and said fixing means is located on the cylindrical surface of said housing means and extends around substantially the full circumference of said housing means.

43. A lighting apparatus as claimed in claim 36 wherein said fixing means securely locates said lighting apparatus in said window and/or comprises an annular seal and/or is integral with the carrier.

44. A lighting apparatus as claimed in claim 37 further comprising a power supply means connected to said lighting element, wherein said power supply means optionally comprises a power cable which exits said lighting apparatus through an end surface of said housing means distant from said illumination means.

45. A lighting apparatus as claimed in claim 37 wherein said lighting element is adapted to remain in the housing means during use and to be removed or replaced when required.

46. A lighting apparatus as claimed in claim 36 wherein an opening is formed in the housing means for insertion of a lighting element therein.

47. A lighting apparatus as claimed in claim 36 wherein said housing means comprises an essentially cylindrically shaped carrier and said carrier is equipped with a substantially cylindrical cover having a handling means provided thereon to enable the lighting apparatus to be removed from or inserted into a glovebox and an open end to facilitate engagement with said carrier, wherein said cover is optionally located at the end of the cylindrical carrier distant from the illumination means.

48. A lighting apparatus as claimed in claim 36 further comprising a sealable vessel adapted to receive and store the carrier.

49. A lighting apparatus as claimed in claim 36 wherein the housing means comprises a substantially cylindrical carrier having an internal cylindrical surface and an external cylindrical surface and, substantially coaxial with the axis of rotation and located on the external wall of the carrier, fixing means comprising a carrier projecting element extending around substantially the full circumference of the external cylindrical wall of the carrier, the carrier projecting element comprising an annular ring being arrayed on the external cylindrical wall of the carrier adjacent an end of the cylinder wherein is comprised illumination means comprising a plurality of LED light sources, and wherein said apparatus is additionally equipped with a substantially cylindrical cover having a handling means provided thereon, said cover being located at the end of the cylindrical carrier distant from the illumination means.

50. A lighting system including a plurality of lighting apparatus as claimed in claim 36, said system further including power means, operable to couple with each lighting apparatus to operate said lighting apparatus and illuminate the contents of the glove box.

51. A method of illuminating a glovebox, said method comprising retrofitting a glove port fitting assembly with a lighting apparatus by means of the steps of:
(a) removing a glove port fitting from a glove box;
(b) replacing said glove port fitting with a window fitting; and
(c) fitting a lighting apparatus as claimed in claim 36 in said window fitting so as to illuminate the glove box.

52. A method as claimed in claim 51, wherein said window fitting comprises a CRL window fitting.

53. A method as claimed in claim 51, wherein said method comprises retrofitting a plurality of glove port fitting assemblies with a lighting system as claimed in claim 51.

54. A method as claimed in claim 51 to at least partially illuminate the glovebox which comprises locating a lighting element in the lighting apparatus and illuminating the contents of the glovebox by rotating the lighting element in the housing means.

55. A method as claimed in claim 51 wherein the material within said glovebox comprises hazardous material, wherein said hazardous material optionally comprises biological or radioactive material, wherein said radioactive material optionally includes substances that emit alpha-particles and said substances that emit alpha-particles optionally comprise plutonium or plutonium compounds, or solutions thereof, or mixtures of uranium and plutonium oxides, or materials used for the manufacture of nuclear fuel, and wherein said radioactive material optionally comprises radioactive waste material which optionally further includes at least partially intact fuel rods and/or at least partially intact fuel canisters.
